(19) United States
(12) Patent Application Publication
(10) Pub. No.: US 2003/0167181 A1
(43) Pub. Date: Sep. 4, 2003

(54) Systems and methods for managing information disclosure statement (IDS) references

(75) Inventors: Steven W. Lundberg, Edina, MN (US); Janal M. Kalis, Minneapolis, MN (US); Shal Jain, New Brighton, MN (US); Pradeep Sinha, Burnsville, MN (US)

Correspondence Address: Schwegman, Lundberg, Woessner & Kluth, P.A., P.O. Box 2938, Minneapolis, MN, 55402, US

(73) Assignee: Schwegman, Lundberg, Woessner & Kluth, P.A.

(21) Appl. No.: 10/087,561

(22) Filed: Mar. 1, 2002

(51) Int. Cl. G06F 17/60

(52) U.S. Cl. 705/1

(57) ABSTRACT

Systems and methods manage information disclosure statement (IDS) references.

### BACKGROUND

Managing information disclosure statement (IDS) references for a number of matters and a number of inventors belonging to a number of organizations is complex and unwieldy for large numbers of matters. Manually managing IDS references and creating IDS forms can be a paperwork nightmare. References can be duplicated, lost, or not properly related to other matters. There is a need to automate this management process as part of an enterprise application and to increase accessibility by providing information on the Internet. With the emergence of web-enabled enterprise applications, security must also be a high priority to make sure IDS references for one matter are not accidentally revealed to a competitor.

### BRIEF DESCRIPTION OF THE DRAWINGS

FIG. 1 is a block diagram of example prior art systems for practicing embodiments of the present invention.

FIG. 2 is a block diagram of a system embodiment of the present invention.

FIG. 3 is a block diagram of a system embodiment of the present invention as an alternate to that in FIG. 2.

FIG. 4 is a block diagram of a system embodiment of the present invention as an alternate to that in FIGS. 2 and 3.

FIG. 5 is a block diagram of example software architecture for practicing embodiments of the present invention.

FIG. 6 is a block diagram of example data access for practicing embodiments of the present invention.

FIG. 7 is a block diagram of example data structures for practicing embodiments of the present invention.

FIG. 8 is a block diagram of a presentation of embodiments of the present invention.

FIG. 9 is a block diagram of a presentation of embodiments of the present invention in addition to that in FIG. 8.

FIG. 10 is a block diagram of a presentation of embodiments of the present invention in addition to those in FIGS. 8 and 9.

FIG. 11 is a block diagram of a presentation of embodiments of the present invention in addition to those in FIGS. 8, 9, and 10.

FIG. 12 is a block diagram of a method embodiment of the present invention.

FIG. 13 is a block diagram of a method embodiment of the present invention in addition to that in FIG. 12.

FIG. 14 is a block diagram of a method embodiment of the present invention in addition to those in FIGS. 12 and 13.

FIG. 15 is a block diagram of a method embodiment of the present invention in addition to those in FIGS. 12, 13, and 14.

FIG. 16 is a block diagram of an example embodiment of the present invention.

### DETAILED DESCRIPTION

Systems and methods for managing information disclosure statement (IDS) references are described. The following detailed description refers to the drawings in this application. The drawings illustrate specific embodiments to practice the present invention and, in these drawings, the same reference numbers are used for substantially similar components. This application describes embodiments of the present invention in sufficient detail to enable those skilled in the art to practice the present invention. In addition, other embodiments that vary in structural, logical, mechanical, and electrical ways do not depart from the scope of the present invention.

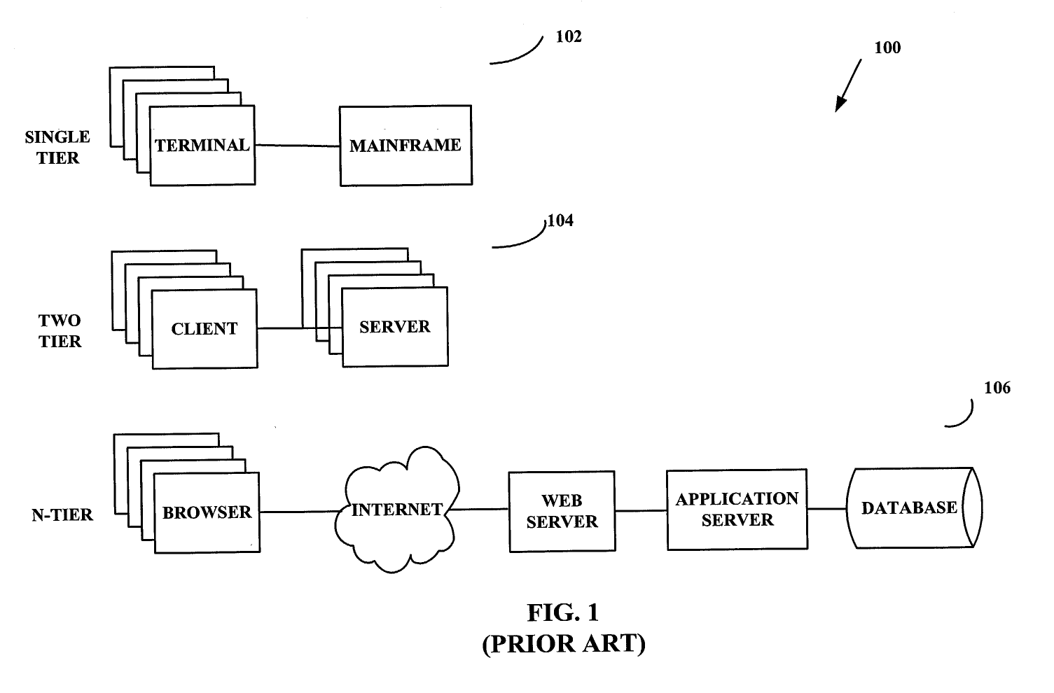

FIG. 1 is a block diagram of example prior art systems 100 for practicing embodiments of the present invention. Embodiments of the present invention are implementable as single-tier 102, two-tier 104, and n-tier computing systems 106. A single-tier system 102 is a centralized application running on a mainframe with a plurality of terminals in communication with the mainframe. A two-tier system 104 is the client-server model. An n-tier system 106 is a plurality of browsers in communication with a web server via the Internet where an application server is in communication with the web server and a database. However, embodiments are not limited to these model computing systems and are implementable on many different computing systems.

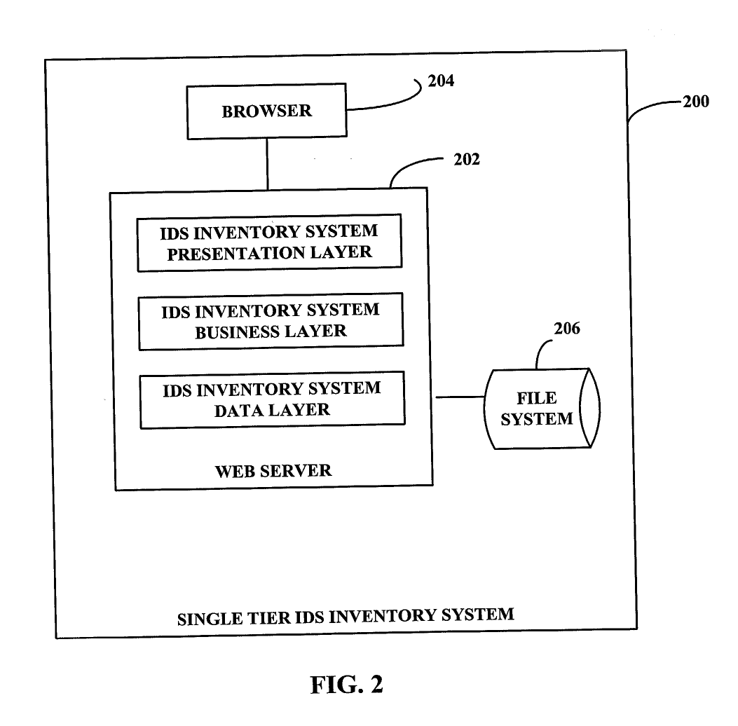

In one embodiment, a system for managing information disclosure statement (IDS) references comprises a computing system, a presentation layer, a business logic layer, and a data layer. (See, for example, FIGS. 2-4). These layers of an application typically build on each other with the data layer being the lowest level, the business logic layer giving context and meaning to the data layer operations, and the presentation layer making the application useful to users. These layers can be arranged and interconnected in many ways. The presentation layer interacts with the user. Graphical user interfaces (GUIs) and web pages are typical examples of presentation layers. The presentation layer sometimes includes a report generator. The business logic layer comprises various business rules and operations that an application performs. The data layer manages the data used by the application for storing data, retrieving data, and the like. The data layer sometimes includes a database application. The presentation layer is operable on the computing system to present an IDS reference inventory system. The business logic layer is operable on the computing system to manage the IDS reference inventory system and to generate IDS forms. The data layer is operable on the computing system to manage the data associated with the IDS reference inventory system.

FIG. 2 is a block diagram of a system embodiment of the present invention. In another embodiment, the computing system 200 comprises a web server 202, at least one browser 204, and a file system 206. The at least one browser 204 is in communication with the web server 202. The file system 206 is accessible to the web server 202. The presentation layer, the business logic layer, and the data layer all operate on the web server 202.

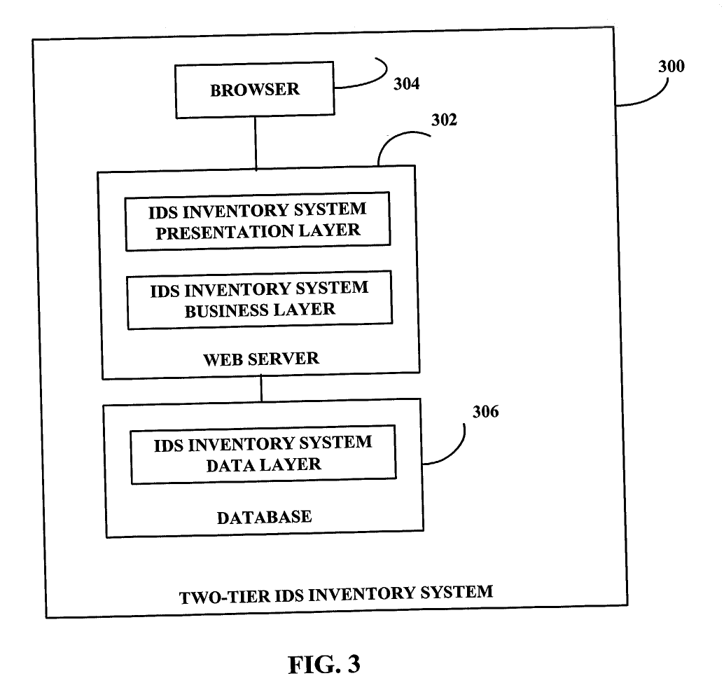

FIG. 3 is a block diagram of a system embodiment of the present invention as an alternate to that in FIG. 2. In another embodiment, the computing system 300 comprises a web server 302, at least one browser 304, and a database management system 306. The at least one browser 304 is in communication with the web server 302. The database management system 306 is accessible to the web server 302. The presentation layer and the business logic layer operate on the web server 302 and the data layer operates on the database management system 306. In one embodiment, the business logic layer includes rules about keeping IDS references belonging to different organizations separate. In this way, organizations do not share IDS references. No individual associated with one organization has access to the IDS references belonging to another organization. In another embodiment, the business logic layer includes an accounting system for tallying the costs of retrieving and/or storing IDS references for each organization.

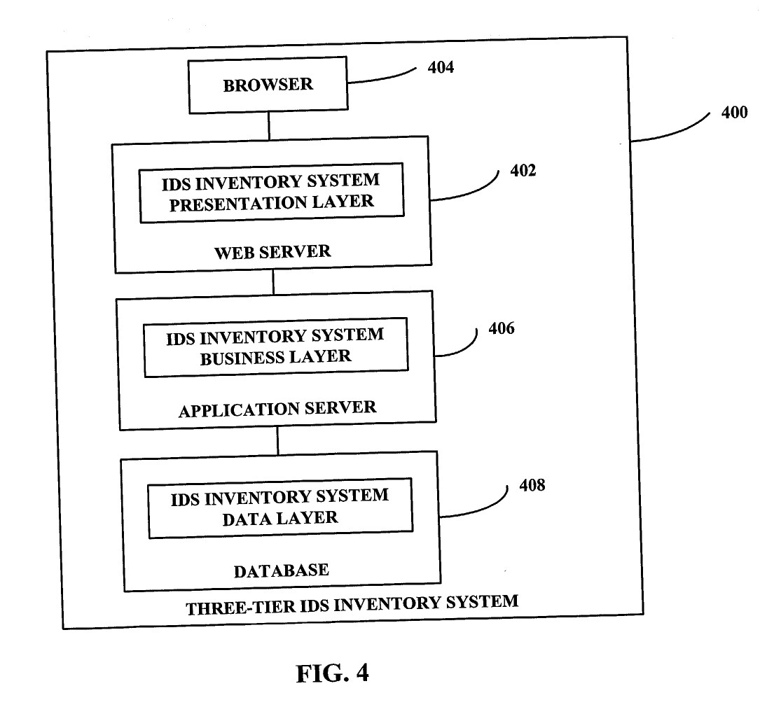

FIG. 4 is a block diagram of a system embodiment of the present invention as an alternate to that in FIGS. 2 and 3. In another embodiment, the computing system 400 comprises a web server 402, at least one browser 404, an application server 406, and a database management system 408. The at least one browser 404 is in communication with the web server 402. The application server 406 is in communication with the web server 402. The database management system 408 in communication with the application server 406. The presentation layer operates on the web server 402, the business logic layer operates on the application server 406, and the data layer operates on the database management system 408.

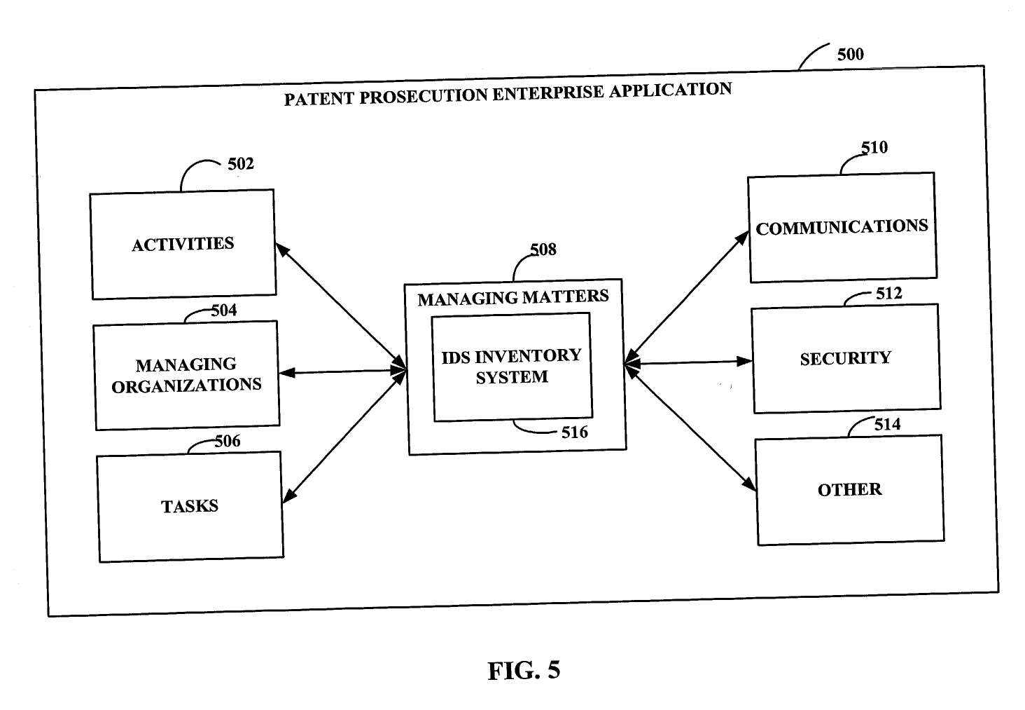

FIG. 5 is a block diagram of example software architecture for practicing embodiments of the present invention. In one embodiment, a patent prosecution enterprise application 500 comprises many software components. The patent prosecution enterprise application is a package or collection of computer applications for supporting a patent prosecution firm's information needs and for supporting its business processes, activities, and tasks. The software components include an activities component 502, a managing organizations component 504, a tasks component 506, a managing matters component 508, a communications component 510, a security component 512 and others 514. The managing matters component 508 comprises an IDS inventory system 516. The managing matters component 508 interfaces with one or more of the other components. In one embodiment, the security component 512 includes permissions indicating who can read, modify, create or delete IDS references. This is based on an individual's role and his or her associated organization in a matter. Components overlap or are combined in some embodiments. Matters are jobs or cases or other associated items. Organizations are entities associated with matters, such as universities, companies, and other firms. Each matter comprises activities and tasks. Individuals associated with organizations are invited into a matter to participate in its activities and tasks. Communications are facilities for managing messages associated with the matters, activities, and tasks.

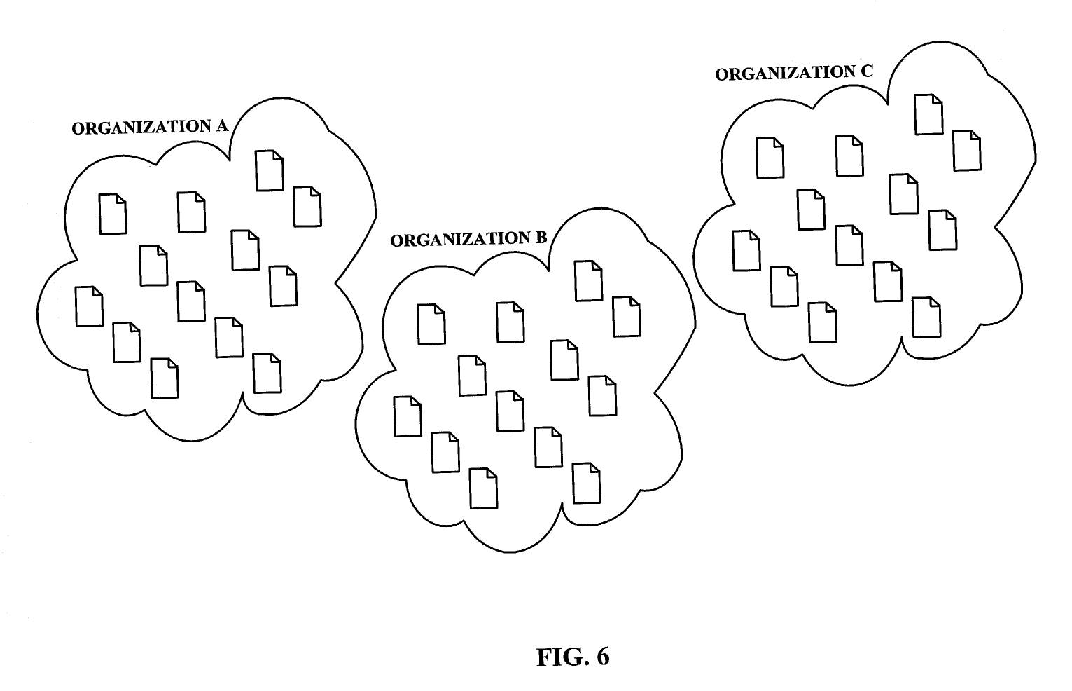

FIG. 6 is a block diagram of example data access for practicing embodiments of the present invention. In one embodiment, a system for managing IDS references comprises a computing system, a first software component and a second software component. The first software component is operable on the computing system to generate a plurality of IDS forms. The second software component is operable on the computing system to manage IDS references for at least one organization. Each organization only has access to its own IDS references. FIG. 6 shows an example system with three organizations, A, B, and C where each organization only has access to its own IDS references. For example, IDS references may be stored in separate storage mediums or stored in files with access codes indicating the associated organization.

In another embodiment, the system further comprises a third software component operable on the computing system to provide a presentation for managing the IDS references associated with each matter of the at least one organization. In another embodiment, the system further comprises a fourth software component operable on the computing system to manage matters 508 (FIG. 5) for the at least one organization. The second software component is a part of the fourth software component.

In another embodiment, the system further comprises fifth, sixth, seventh, eighth, and ninth software components. The fifth software component operable on the computing system to manage activities 502 (FIG. 5) within matters. The sixth software component operable on the computing system to manage organizations 504 (FIG. 5). The seventh software component operable on the computing system to manage tasks 506 (FIG. 5) within matters. In one embodiment, matters comprise activities, which in turn comprise tasks. In this embodiment, managing matters includes managing activities, which in turn includes managing tasks. The eighth software component operable on the computing system to provide communications 510 (FIG. 5). The ninth software component operable on the computing system to provide security 512 (FIG. 5). The third, fourth, fifth, sixth, seventh, eighth, and ninth software components are capable of interfacing with the first and second software components in a patent prosecution enterprise application 500 (FIG. 5).

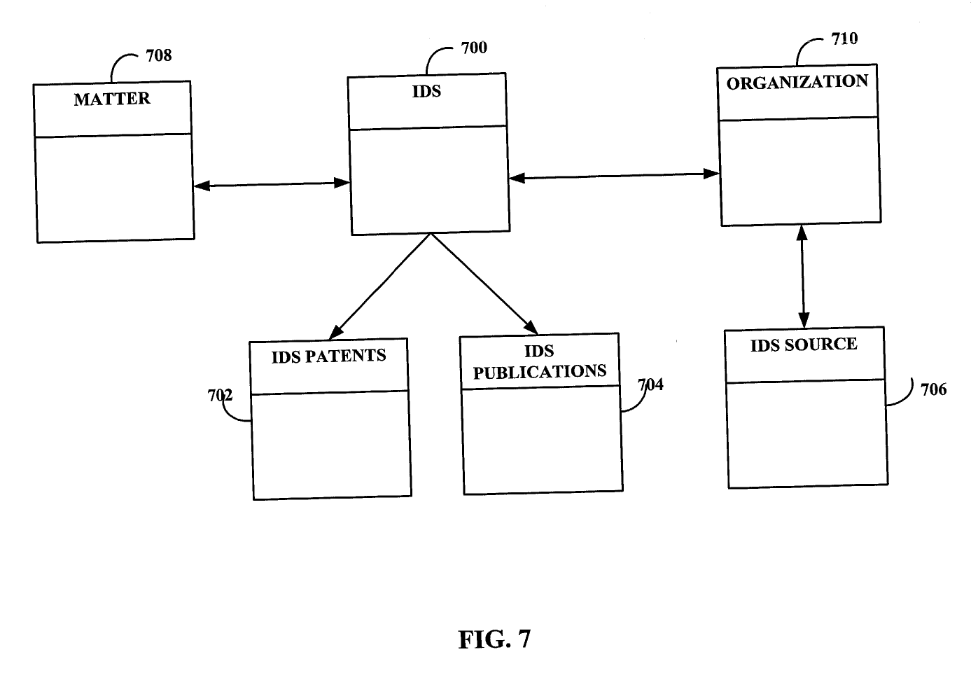

FIG. 7 is a block diagram of example data structures for practicing embodiments of the present invention. In another embodiment, the IDS references comprise an IDS holder 700, an IDS patents holder 702, an IDS publications holder 704, and an IDS source holder 706. The IDS patents holder 702 is related to the IDS holder 700. The IDS publications holder 704 is related to the IDS holder 700. In one embodiment, the IDS holder 700 contains information applicable to all IDS references for each matter, while the IDS patents holder 702 and IDS publications holder 704 contains information applicable to specific IDS references, such as title, date, etc. The IDS source holder 706 indicates how to access the stream of data associated with each IDS reference. For example, a particular IDS reference may be a scanned image in a file in portable document format (PDF). In this example, the source holder contains a pointer to a memory or storage location where the .pdf file is stored. Embodiments of the present invention include IDS references in many other formats, including rich text format (RTF), hypertext markup language (HTML), LaTeX, Extensible Markup Language (XML), and other file formats. In another embodiment, the IDS source holder 706 indicates a website for downloading an IDS reference from a commercial database or another site, such as http://patft.uspto.gov/netahtml/search-bool.html. In another embodiment, the system further comprises a matter holder 708 and an organization holder 710. The matter holder 708 is related to the IDS holder 700. The organization holder 710 is related to both the IDS holder 700 and the IDS source holder 706. In one embodiment, there is an additional holder between the matter holder 708 and the IDS holder 700 that includes an indication of whether a reference has been translated, and if the reference is a foreign publication document. This additional holder also includes whether the reference has been reviewed and marked. In another embodiment, the system further comprises a database management system to manage the holders. In another embodiment, the holders are tables and the data management system is a relational database management system. In another embodiment, the holders are classes and the data management system is an object-oriented database management system. In another embodiment, each IDS reference has a unique identifier.

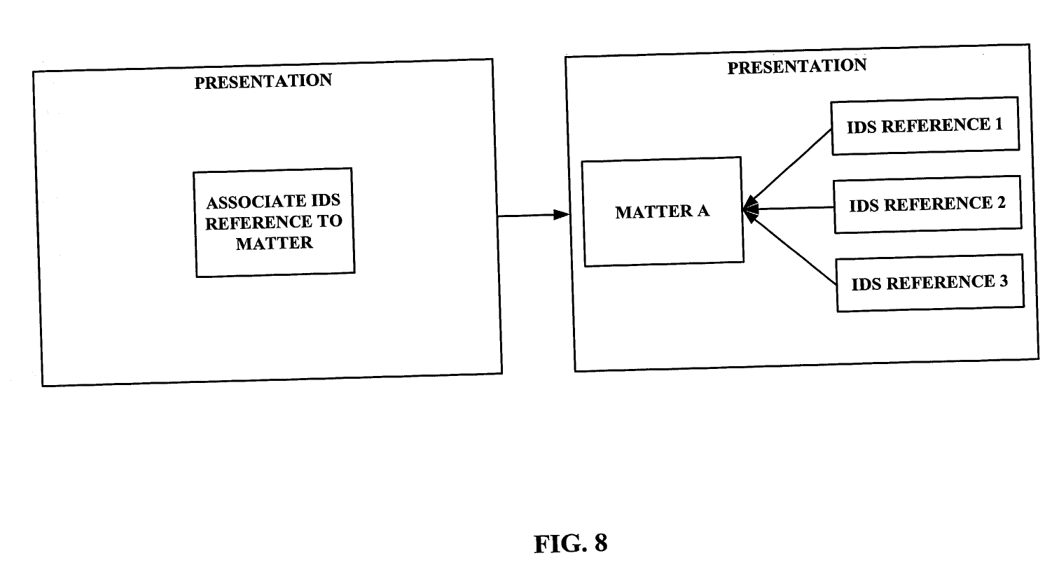

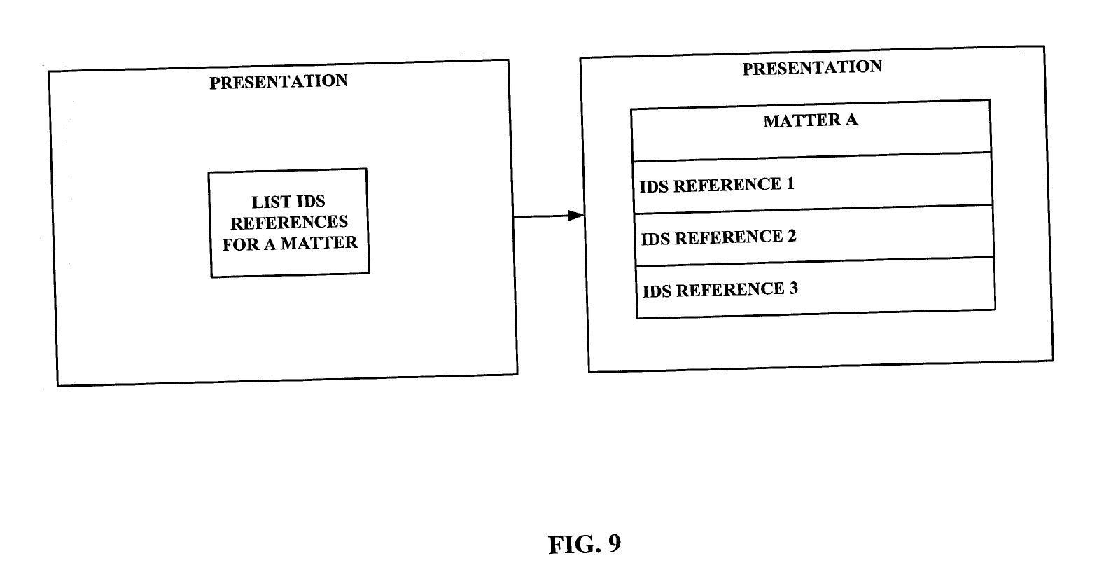

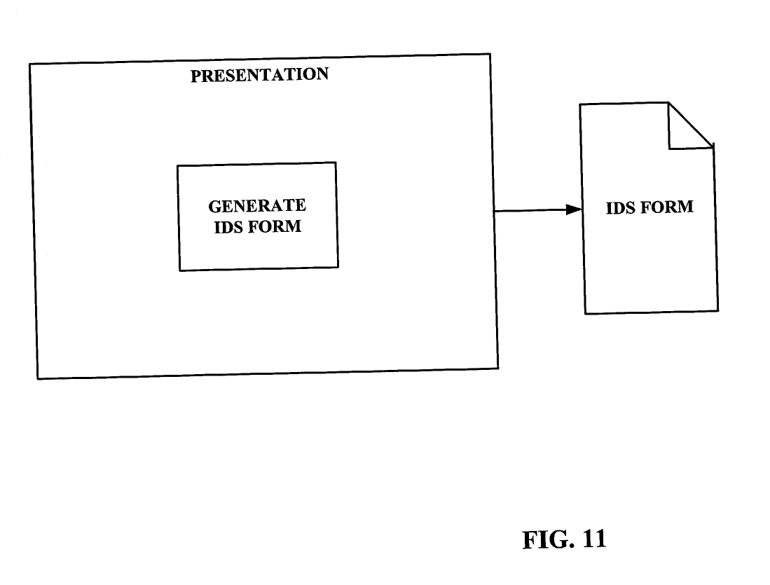

FIGS. 8-11 are block diagrams of presentations of embodiments of the present invention. In another embodiment, a computer-readable medium stores computer-executable instructions for performing a method. A number of presentations are provided. These presentations can be organized and combined in various ways. One presentation is capable of associating at least one IDS reference to at least one matter as shown in FIG. 8. Another presentation is capable of listing each IDS reference associated with each matter, as shown in FIG. 9. In another embodiment, the listing presentation is capable of filtering IDS references on whether they have been marked or reviewed. In another embodiment, a presentation is capable of generating an IDS form for at least one matter, as shown in FIG. 11.

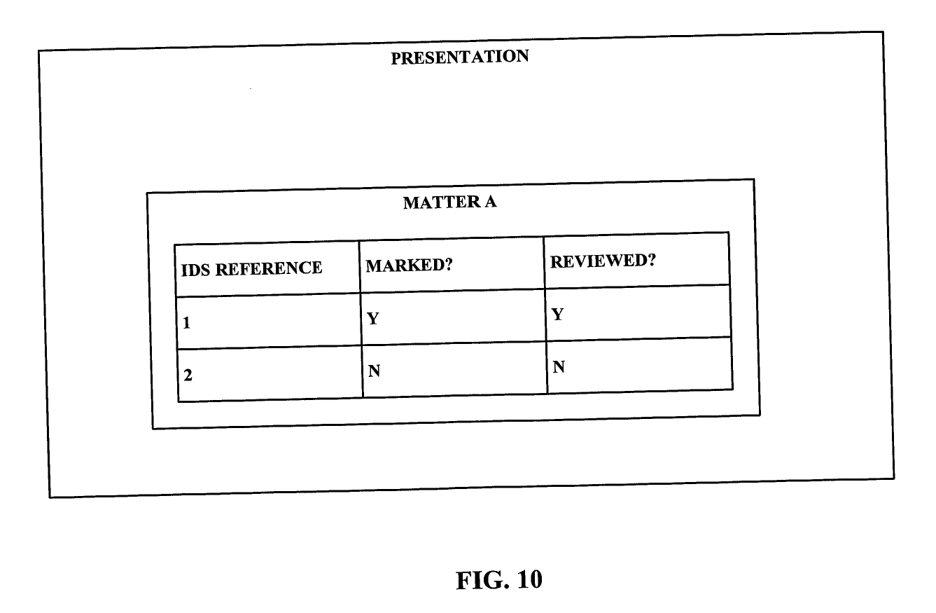

In another embodiment, a presentation is capable of modifying at least one IDS reference associated with at least one matter. In another embodiment, a presentation is capable of deleting at least one IDS reference associated with at least one matter. In another embodiment, a presentation is capable of searching all IDS references associated with one matter. In another embodiment, a presentation is capable of searching all IDS references owned by one organization. In another embodiment a presentation is capable of marking at least one IDS reference associated with at least one matter. See FIG. 10. In another embodiment, a presentation is capable of updating a review status of at least one IDS reference associated with at least one matter. See FIG. 10. In another embodiment, a presentation is capable of showing the review status of each IDS reference associated with at least one matter. See FIG. 10.

In another embodiment, access is restricted to IDS references so that each organization only has access to its own IDS references, unless an individual from a first organization is invited into a matter of a second organization. If an individual, George, who belonged to organization “A” is invited into the matter 1234.56 belonging to organization “B” then George only has access to selected parts of matter 1234.56 and no access to any of the other matters belonging to organization “B.” Furthermore, only George and no other members of organization “A” has access to matter 1234.56. In other words, George has exclusive access by invitation only. In another embodiment, an accounting system is provided to track costs associated with storing IDS references. In another embodiment, presentation capabilities for each individual are determined based on their role in a matter and an organization associated with each individual.

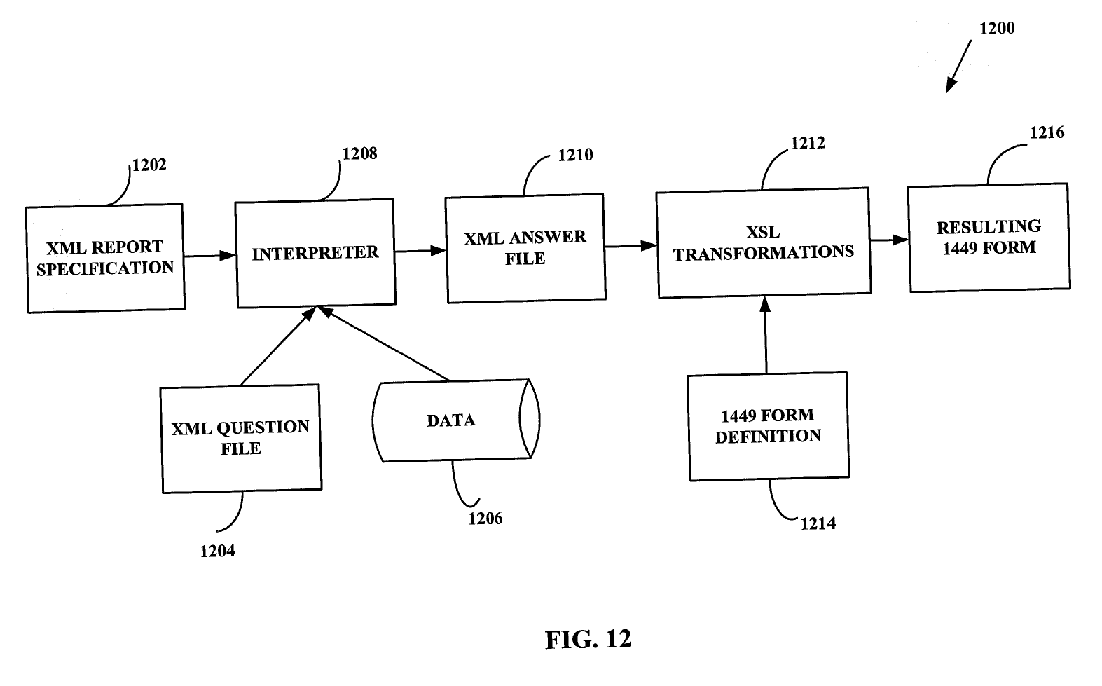

FIG. 12 is a block diagram of a method embodiment of the present invention. FIG. 12 shows an example reporting process 1200 for producing an IDS form. An XML report specification 1202, an XML question file 1204, and other data 1206 is input to an interpreter 1208. The interpreter 1208 creates an XML answer file 1210. The answer file 1210 is used by a number of Extensible Stylesheet Language Transformations (XSLT) 1212 along with a 1449 form definition 1214, such as one based on the file http://www.uspto.gov/web/forms/sb0008.pdf to create the resulting 1449 form 1216. Another embodiment is a method for producing a number of different reports, including an IDS form. A report specification 1202 is received and interpreted 1208 and an answer file 1210 is generated. A plurality of transformations 1212 are received. The transformations 1212 act on the answer file 1210 and a form definition file 1214. Then, the resulting report 1216 is provided. In one embodiment, the report is an IDS form. In another embodiment, the method for producing the reports further comprises receiving and reading a question file 1204, while interpreting 1208 the report specification 1202.

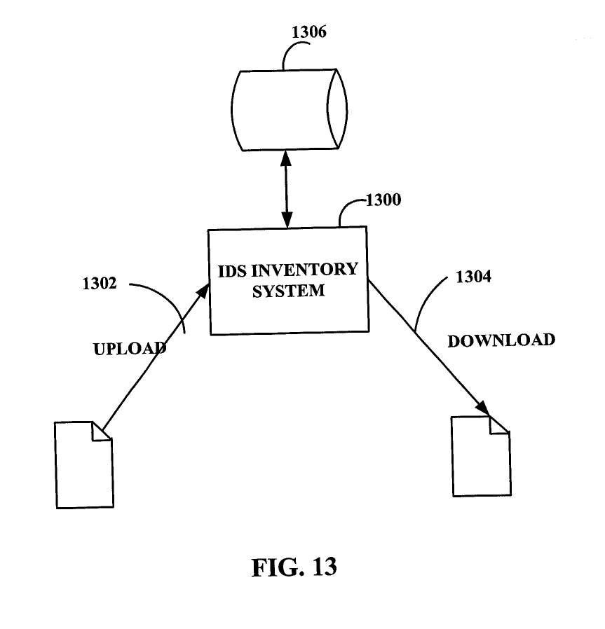

FIG. 13 is a block diagram of a method embodiment of the present invention in addition to that in FIG. 12. The IDS inventory system 1300 is shown uploading IDS data 1302 and downloading IDS data 1304 with the capacity to store the IDS data in a storage medium 1306. In another embodiment, a presentation is capable of uploading a stream of data associated with the at least one IDS reference 1302. In another embodiment, a presentation is capable of downloading the stream of data associated with the IDS reference 1304. In another embodiment, links are provided for various applications capable of opening and displaying the stream of data.

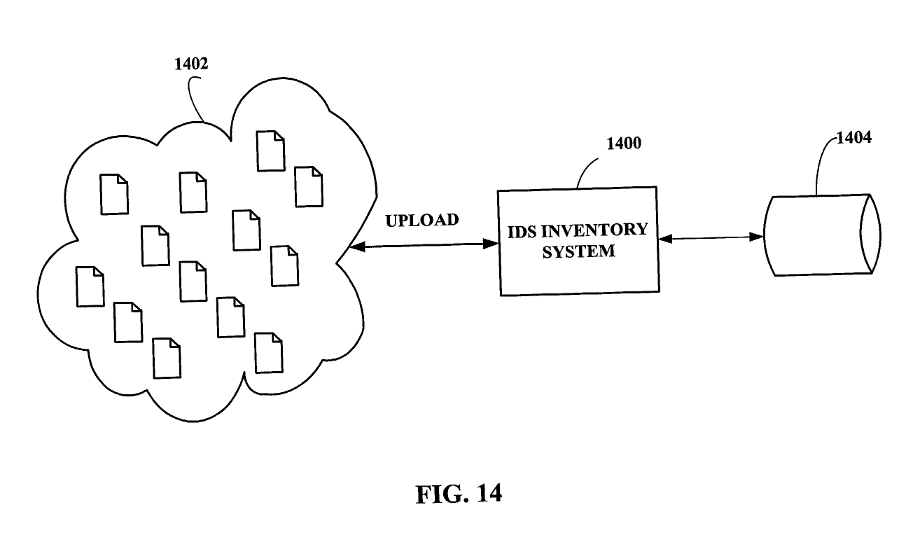

FIG. 14 is a block diagram of a method embodiment of the present invention in addition to those in FIGS. 12 and 13. FIG. 14 shows an IDS inventory system 1400 doing a bulk upload of data for a number of IDS references 1402 with the capacity to store the data in a storage medium 1404. In another embodiment, a presentation is capable of uploading a plurality of streams of data associated with IDS references, the IDS references being associated with a plurality of matters.

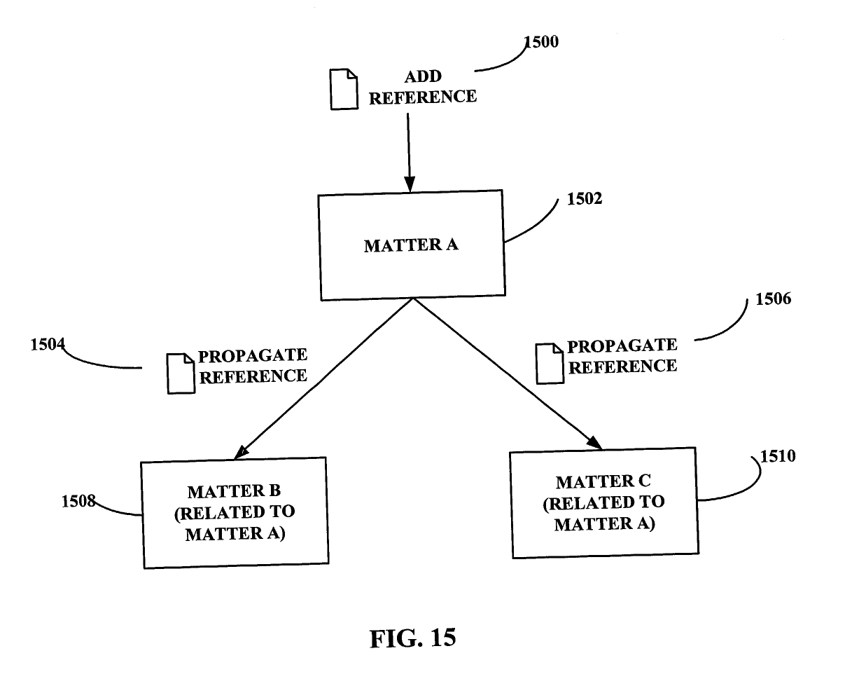

FIG. 15 is a block diagram of a method embodiment of the present invention in addition to those in FIGS. 12, 13, and 14. FIG. 15 shows how a reference propagates to related matters when it is added to a matter. When a reference is added 1500 to matter A 1502, it is propagated to all matters related to matter A that also meet certain criteria. Criteria include whether the matter is a patent application, a reissue application, whether the matter is allowed, or pending, and the like. In FIG. 15, the reference is propagated 1504, 1506, to related matters B 1508 and C 1510. In one embodiment, a presentation listing IDS references for a matter has a special presentation mode for propagated IDS references, such as displaying them in a different color. Another embodiment is a method for managing IDS references. A request is received to add a new IDS reference to a first matter. All matters related to the first matter are searched. The new IDS reference is added to selected matters related to the first matter. In another embodiment, duplicate IDS references are not permitted. In another embodiment, only those matters related to the first matter with a matter type that supports IDS reference management and only those matters having an appropriate stage are selected. Generally, embodiments of the present invention provide many ways of propagating references. In another embodiment, a list of IDS references for a second matter are presented, wherein the second matter is related to the first matter. The new IDS reference in the list is indicated as having originated in the first matter. In another embodiment, the new IDS reference is indicated as being unmarked and unreviewed. Unmarked means that a particular IDS reference has not been marked to be included in an IDS form. Unreviewed means that a responsible attorney has not yet reviewed a particular IDS reference. In another embodiment, IDS forms include only those marked and reviewed IDS references for a matter that have not previously been included in a IDS form. In another embodiment, a default for IDS references is unmarked and unreviewed.

Another embodiment is a system that comprises a host organization and a plurality of attorneys. The host organization manages a plurality of matters. Some of the plurality of attorneys belong to different law firms associated with the plurality of matters. A first set of attorneys of the plurality of attorneys are associated with a first law firm. These attorneys have access to selected matters in the plurality of matters, but have no access to other matters in the plurality of matters. Attorneys other than those in the first set of attorneys are associated with at least one law firm other than the first law firm and have access to matters other than the selected matters. A reference associated with one of the selected matters is propagated to a new matter that is not in the selected matters. The attorneys other than those in the first set of attorneys do not have access to the new matter.

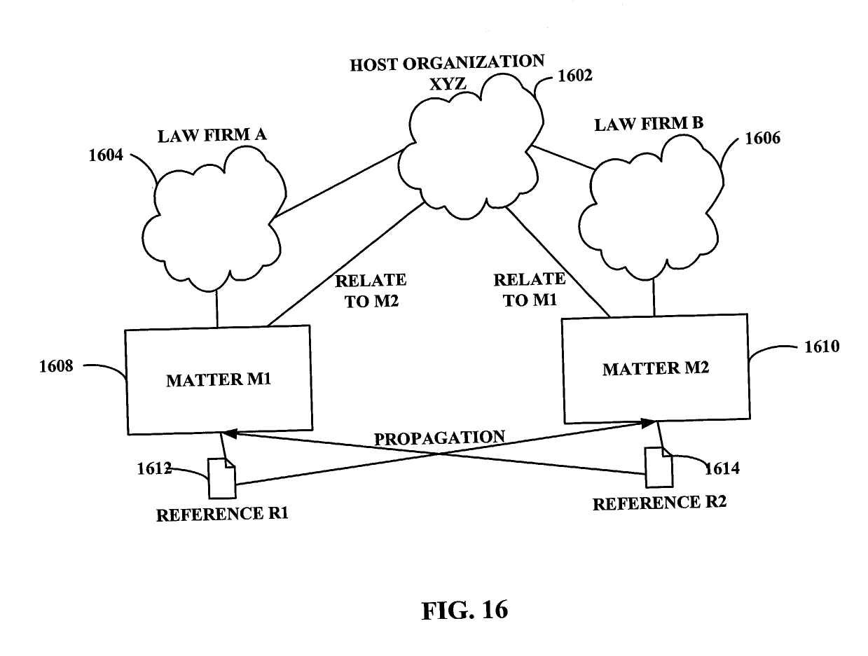

FIG. 16 is a block diagram of an example embodiment of the present invention. Suppose the system is hosted by organization XYZ 1602. XYZ 1602 owns a number of matters. XYZ 1602 deals with two law firms, law firm A 1604 and law firm B 1606. Attorneys at law firm A 1604 are invited to matter m1 1608. Attorneys at law firm B 1606 are invited to matter m2 1610. In matter m1 1608, there is a reference r1 1612. In matter m2 1610, there is a reference r2 1614. The attorneys at law firm A 1604 can only see matter m1 1608 and the attorneys at law firm B 1606 can only see matter m2 1610. Furthermore, they can't see each other. When someone from XYZ 1602 relates matter m1 1608 to matter m2 1610 and the IDSes propagate, matters m1 1608 and m2 1610 both now have references r1 1612 and r2 1614. Now, attorneys from law firm A 1604 can see that reference r2 1614 came into matter m1 1608 from matter m2 1610, but they can't see any part of matter m2 1610.

It is to be understood that the above description it is intended to be illustrative, and not restrictive. Many other embodiments are possible and some will be apparent to those skilled in the art, upon reviewing the above description. For example, other embodiments include Active Server Pages (ASPs), Common Gateway Interface (CGI) scripts, and NET platform and more. Therefore, the spirit and scope of the appended claims should not be limited to the above description. The scope of the invention should be determined with reference to the appended claims, along with the full scope of equivalents to which such claims are entitled.

What is claimed is:

1. A system for managing information disclosure statement (IDS) references, comprising:
a computing system;
a first software component operable on the computing system to generate a plurality of IDS forms; and
a second software component operable on the computing system to manage IDS references for at least one organization;
wherein each organization only has access to its own IDS references.

2. The system as recited in claim 1, further comprising:
a third software component operable on the computing system to provide a presentation for managing the IDS references associated with each matter of the at least one organization.

3. The system as recited in claim 2, further comprising:
a fourth software component operable on the computing system to manage matters for the at least one organization;
wherein the second software component is a part of the fourth software component.

4. The system as recited in claim 3, further comprising:
a fifth software component operable on the computing system to manage activities within matters;
a sixth software component operable on the computing system to manage organizations;
a seventh software component operable on the computing system to manage tasks within matters;
an eighth software component operable on the computing system to provide communications; and
a ninth software component operable on the computing system to provide security;
wherein the third, fourth, fifth, sixth, seventh, eighth, and ninth software components are capable of interfacing with the first and second software components in a patent prosecution enterprise application.

5. The system as recited in claim 1, wherein the IDS references comprise:
an IDS holder;
an IDS patents holder related to the IDS holder;
an IDS publications holder related to the IDS table; and
an IDS source holder to indicate how to access the stream of data associated with each IDS reference.

6. The system as recited in claim 5, further comprising:
a matter holder related to the IDS holder; and
an organization holder related to both the IDS holder and the IDS source holder.

7. The system as recited in claim 6, further comprising:
a database management system to manage the holders.

8. The system as recited in claim 7, wherein the holders are tables and the data management system is a relational database management system.

9. The system as recited in claim 8, wherein the holders are classes and the data management system is an object-oriented database management system.

10. A method for reporting, comprising:
receiving a report specification;
interpreting the report specification;
generating an answer file;
receiving a plurality of transformations to act on the answer file and a form definition file; and
providing a report.

11. The method as recited in claim 10, wherein the report is an information disclosure statement (IDS) form.

12. The method as recited in claim 10, further comprising:
receiving a question file;
wherein interpreting the report specification includes reading the question file.

13. A method for managing information disclosure statement (IDS) references, comprising:
receiving a request to add an new information disclosure statement (IDS) reference to a first matter;
searching for all matters related to the first matter; and
adding the new IDS reference to selected matters related to the first matter.

14. The method as recited in claim 13, further comprising:
selecting only those matters related to the first matter with a matter type that supports IDS reference management and only those matters having an appropriate stage.

15. The method as recited in claim 13, further comprising:
presenting a list of IDS references for a second matter, wherein the second matter is related to the first matter; and
indicating the new IDS reference in the list originated in the first matter.

16. The method as recited in claim 15, further comprising:
indicating the new IDS reference is unmarked and unreviewed.

17. A system for managing information disclosure statement (IDS) references, comprising:
a computing system;
a presentation layer operable on the computing system to present an information disclosure statement (IDS) reference inventory system;
a business logic layer operable on the computing system to manage the IDS reference inventory system and to generate IDS forms; and
a data layer operable on the computing system to manage the data associated with the IDS reference inventory system.

18. The system as recited in claim 17,
wherein the computing system comprises:
a web server;
at least one browser in communication with the web server; and
a file system accessible to the web server;
wherein the presentation layer, the business logic layer, and the data layer operate on the web server.

19. The system as recited in claim 17,
wherein the computing system comprises:
a web server;
at least one browser in communication with the web server; and
a database management system accessible to the web server;
wherein the presentation layer and the business logic layer operate on the web server and the data layer operates on the database management system.

20. The system as recited in claim 17,
wherein the computing system comprises:
a web server;
at least one browser in communication with the web server;
an application server in communication with the web server; and
a database management system in communication with the application server;
wherein the presentation layer operates on the web server, the business logic layer operates on the application server, and the data layer operates on the database management system.

21. A computer-readable medium storing computer-executable instructions for performing a method, the method comprising:
providing a presentation capable of associating at least one information disclosure statements (IDS) reference to at least one matter; and
providing a presentation capable of listing each IDS reference associated with each matter.

22. The method as recited in claim 21, further comprising:
providing a presentation capable of generating an IDS form for at least one matter.

23. The method as recited in claim 21, further comprising:
providing a presentation capable of modifying at least one IDS reference associated with at least one matter.

24. The method as recited in claim 21, further comprising:
providing a presentation capable of deleting at least one IDS reference associated with at least one matter.

25. The method as recited in claim 21, further comprising:
providing a presentation capable of searching all IDS references associated with one matter.

26. The method as recited in claim 21, further comprising:
providing a presentation capable of searching all IDS references owned by one organization.

27. The method as recited in claim 21, further comprising:
providing a presentation capable of marking at least one IDS reference associated with at least one matter.

28. The method as recited in claim 21, further comprising:
providing a presentation capable of updating a review status of at least one IDS reference associated with at least one matter; and
providing a presentation capable of showing the review status of each IDS reference associated with at least one matter.

29. The method as recited in claim 21, further comprising:
restricting access to IDS references so that each organization only has access to its own IDS references, unless an individual from a first organization is invited into a matter of a second organization.

30. The method as recited in claim 21, further comprising:
providing an accounting system to track costs associated with storing IDS references.

31. The method as recited in claim 21, wherein
presentation capabilities for each individual are determined based on their role in a matter and an organization associated with each individual.

32. The method as recited in claim 21, further comprising:
providing a presentation capable of uploading a stream of data associated with the at least one IDS reference.

33. The method as recited in claim 32, further comprising:
providing a presentation capable of downloading the stream of data associated with the IDS reference.

34. The method as recited in claim 32, further comprising:
providing links for various applications capable of opening and displaying the stream of data.

35. The method as recited in claim 21, further comprising:
providing a presentation capable of uploading a plurality of streams of data associated with IDS references, the IDS references being associated with a plurality of matters.

36. A system, comprising:
a host organization managing a plurality of matters; and
a plurality of attorneys some of which belong to different law firms associated with the plurality of matters;
wherein a first set of attorneys of the plurality of attorneys are associated with a first law firm and have access to selected matters in the plurality of matters, but have no access to other matters in the plurality of matters;
wherein attorneys other than those in the first set of attorneys are associated with at least one law firm other than the first law firm and have access to matters other than the selected matters;
wherein a reference associated with one of the selected matters is propagated to a new matter that is not in the selected matters;
wherein the attorneys other than those in the first set of attorneys do not have access to the new matter.
